(19) United States
(12) Patent Application Publication
(10) Pub. No.: US 2014/0344026 A1
(43) Pub. Date: Nov. 20, 2014

(54) Unified parking management system and method based on optical data processing

(71) Applicants: Chris Outwater, Santa Barbara, CA (US); William Gibbens Redmann, Glendale, CA (US)

(72) Inventors: Chris Outwater, Santa Barbara, CA (US); William Gibbens Redmann, Glendale, CA (US)

(21) Appl. No.: 14/219,213

(22) Filed: Mar. 19, 2014

Related U.S. Application Data
(60) Provisional application No. 61/803,269, filed on Mar. 19, 2013.

(51) Int. Cl. G07B 15/02

(52) U.S. Cl. CPC G07B 15/02
USPC 705/13

(57) ABSTRACT

A system and method for unified parking management based on optical data processing from installed cameras. The invention can be used in both on-street and off-street parking situations. The system allows for economical dynamic pricing based on demand, profiles and loyalty, and how much a motorist is willing to pay at any given time for a parking space similar to frequent flier programs and seats on a flight. Prices can be constantly changing based on demand, which in turn can be based on time of day, convenience, services available and loyalty.

This application is related and claims priority from U.S. Provisional patent application No. 61/803,269 filed Mar. 19, 2013. Application 61/803,269 is hereby incorporated by reference.

### BACKGROUND

1. Field of the Invention

The present invention relates generally to parking management and more particularly to a system and method for unified parking management based on optical data processing.

2. Description of the Prior Art

There is a growing need for monitoring and billing for both parking and Electric Vehicle (EV) charging in an economical manner. Present parking facilities have a combination of gates, attendants, cameras and the like. Also, some parking facilities have web sites and signs that report the number of remaining empty spaces. Usually, there is no distinction between parking spaces. Once a motorist has passed through the gate or otherwise entered the lot, they are free to choose any space. In some cases, attendants park vehicles for the motorist, and in some cases, groups of spaces are reserved. However, there is no coherent way of managing spaces, fees, demand or motorist loyalty.

Parking lot owners and managers are generally seeking the least expensive way to allow authorized parking, to manage and control fees in various parking zones, and to allow convenient usage of higher rate parking based on time of day, demand, and whether electric vehicle charging facilities are installed in their parking facilities. Also, not all parking is in lots. Cities and private companies operate numerous on-street parking spaces nationwide. Some parking lots are equipped with cameras that can identify license plates (License Plate Recognition LPR), others are equipped with wide-angle surveillance cameras. However, optical data from these two types of system are not combined and are generally only used for security. Many parking space inventory tracking systems alone require costly hardware to be added in the pavement under the parking space or added to a parking meter.

### SUMMARY OF THE INVENTION

The present invention relates to a system and method for unified parking management based on optical data processing from installed cameras. The invention can be used in both on-street and off-street parking situations. The system allows for economical dynamic pricing based on demand, profiles and loyalty, and how much a motorist is willing to pay at any given time for a parking space similar to frequent flier programs and seats on a flight. Prices can be constantly changing based on demand, which in turn can be based on time of day, convenience, services available and loyalty.

In some embodiments of the invention, a monitored parking area could have a system like air traffic control, where the system guides each vehicle to the next available spot and give the pricing, or guides to a pre-determined space based on services or a price chosen by the motorist.

This unified parking management system allows the highest value to go to both the parking space owner and the motorist. This can then be automatically tied to other community or loyalty advantage programs.

The present invention solves the parking management problem with optical pattern recognition such as LPR plus traditional machine vision and color analysis, if needed, as an additional data point. The optical information gathered about the vehicle, whether an electric vehicle or not, can be tied to location and time stamping for each vehicle. Neither LPR alone, nor traditional machine vision and pattern recognition alone, is able to solve this vehicle tracking problem in an economical fashion. However, a combination of these two techniques can. Tied together according to the present invention, the data gathering methods and system can handle parking access (if gated, or attendant), control, billing and special attributes for parking spaces both economically and with high confidence.

### DESCRIPTION OF THE FIGURES

Attention is now directed to the following figures.

FIG. 1 shows an overview of a parking facility according to the present invention.

FIG. 2 shows camera coverage in a parking facility.

FIG. 3 is a vehicle position state transition diagram.

FIG. 4 is a transition table identifying the legitimate location for a vehicle.

FIG. 5 is a parking rate table.

FIG. 6 is a flowchart for a process managing the transaction for a vehicle in a parking facility using a grace period.

FIG. 7. is a table of data representing a sequence of observable events in a parking facility.

FIG. 8 is a table of data representing a different sequence of events from those of FIG. 7.

FIG. 9 is a flowchart of a process managing the transaction for a vehicle in a parking facility using license plate cameras.

Several drawings and figures have been presented to illustrate features of the present invention. The scope of the present invention is not limited to what is shown in the figures.

### DESCRIPTION OF THE PREFERRED EMBODIMENTS

As previously stated, the present invention solves the parking management problem with optical pattern recognition such as LPR and/or traditional machine vision and color analysis, if needed, as an additional data point. One example of this is a Kinect™ camera system from Microsoft Corp. of Redmond Wash. which can additionally determine a 3-dimensional shape of the vehicle. The optical information gathered about the vehicle, whether an EV or not, can be tied to location and time stamping for each vehicle. Neither LPR alone, nor traditional machine vision and pattern recognition alone, is able to solve this vehicle tracking problem in an economical fashion. However, a combination of these two techniques can. The least expensive way to manage parking areas is with no gates, no pay stations, no attendants and no costly hardware. LPR alone can be used to handle tracking upon ingress and egress for parking areas. However, once the vehicle is inside the parking area, it is outside the working field of the LPR devices which take a close snapshot of the vehicle's license plate for OCR processing. Other cameras, even a plurality of high definition cameras are typically not able to accurately ID a given vehicle from a distance with perfect reliability. However, the combination of the two types of data gathering, close up LPR and distant wide view, when tied together with techniques known in the pattern recognition industry, can economically record and monitor access to a parking area and specific zones within a parking area, those zones comprising special attributes such as proximity to building access or Electric vehicle service EVSE for EV charging.

The most economical way to allow EV charging is with no physical access control on the EVSE. Access control and reporting is expensive and complicated. If there is no access control on the EVSE, and if the owner wants to monitor and bill for usage of the EVSE, the owner must rely on both vehicle ID and vehicle location in the parking area through some means so that a specific vehicle can be known to have entered a specific parking area, progressed to a location and parked at a specific parking spot in that location in the parking area for some period of time. As an added attribute, if the vehicle is an EV, then the motorist can plug his EV into an EVSE, if that area is equipped with EVSE as an attribute, and also be tracked until the exit of the parking and charging area and the parking lot in general. This can be tied to monitoring the actual usage of electricity at that parking space using a metering method. The easiest way is to just bill for time in a specific parking area or space. If owner wants to bill for electricity used to charge an EV, then the owner also needs to meter the EVSE at that space.

The optical monitoring system of the present invention can also become a unified optical monitoring system that also includes general surveillance features, plus vehicle tracking for access and billing and parking space inventory tracking all in one system. This information can be provided very economically. The optical methods proposed in the present invention do not require costly hardware to be installed at each parking space. On the contrary, the present invention allows a large number of parking spaces to be monitored by a single camera and illuminator (if needed); this brings the cost per space down significantly. Pattern recognition technology known in the industry can be used to track motion and expected motion through an area as an object transitions from the field of view of one camera to another. The combination of this technology with LPR offers a unique method for tracking ingress and egress of known, registered vehicles and also unknown, transient, non-registered vehicles. Vehicles that are not registered are able to enter and park in un-gated and unmanned parking areas; however, if the motorists do not heed the signage instructing them to go online or call in to the parking management offices to register their license plate they can be issued citations. A particular embodiment of the present invention can also enforce parking by issuing citations based on the license plate number and also have optical proof of violation of clearly posted signage and policy. This enforcement can take place automatically since the system can process parking profiles for registered, long term, and also for (non registered, or minimally registered, i.e., LP and credit card) transient parking customers and issue citations when any motorist goes beyond the profile and policies identified by the parking area owner.

The present invention utilizes a combination of pinch points and general pattern recognition techniques along with time and motion as well as statistical analysis to identify vehicles on entry, track where the vehicle goes in the parking area, and follow that vehicle until it is parked in a specific parking zone. The present invention does not rely on special parking zones, and can work in any parking area; however, it allows the owner to easily create and bill for parking zones with special attributes. This has great value not only for billing purposes, but also for general tracking of parking spaces available in large parking structures.

For any parking area or structure the entrance and exit points (which may be the same) can be called pinch points. It is at the pinch points that the system can gather the initial data about each vehicle that is entering the area. These data are comprised of both the “close up” vehicle information, such as a high definition image of the vehicle's license plate, which is known in the art of parking enforcement, and also capture a “wider view” of the general vehicle features. The wider view can include illuminating the vehicle with a light source of one optical wavelength or multiple wavelengths and noting the reflection from the surface of the target vehicle so that a color or light signature can be added to the data for that vehicle. In one embodiment, the illuminating light is pulsed and filtered so as to eliminate the interference of any ambient light in recording the vehicle's color signature. In addition, a database of all manufacturer's colors for all vehicles based on this illumination could be created as a reference, if needed.

The unique license plate state information and number can itself lead to the knowledge of the make and model and year the vehicle was assigned to that plate. In addition, the “wider view” of the present invention also supplies the general type, make, model, year in addition to the optionally captured, color signature. The “close up” view of the license plate and the “wider view” of the vehicle, including color signature, are instantly tied together in a database along with the location and time stamp. Because “scan and authenticate” time is not of the essence in these parking area situations, unlike event access parking, the cameras can be inexpensive and capture images, cache them, and upload them through wired or wireless methods to a secure remote server for image processing. The combination of the two vehicle ID views offers the advantage of both knowing the exact ID of the vehicle by virtue of the license plate data, but also being able to track that vehicle using a small number of less expensive cameras that can cover a large parking area. In some cases, that area can include various special rate zones, or other zones, including an EV charging area, or an automatic car wash.

Like many LPR cameras, the “wider view” cameras, in some cases, have their own light sources. This is the case if the lot is an outdoor parking area that has various lighting conditions during the day or night while the vehicle is in the parking area. If the “wider view” tracking cameras have their own, known light sources, essentially the same wavelength or wavelength band can used at the initial entrance pinch point. This can add to the confidence in tracking a vehicle through the parking area under all possible lighting conditions. General vehicle information in the “wider view” is known in the art in the parking enforcement industry for electronic chalking purposes. TanneryCreek offers an electronic chalking solution that does not use LPR, but does use GPS location information, plus a wide view of the vehicle and street in order to “chalk” the vehicle. However, this wider view and the close up LPR view of the present invention, (the “combined views” plus optional color information) give highly accurate vehicle ID along with tracking vehicle movement within the parking area. This technique of the present invention of combining “close up” with “wider views” and an optional color signature allows a parking area owner and controller to track the vehicle entrance, movement through the parking areas, and eventual parking location and parking lot status, using inexpensive, wide angle cameras, and not having to supply expensive LPR cameras or other parking space vehicle sensors at all of the parking space locations.

If there is a parking area with a cluster of EVSE, (a cluster is likely because this will lower the installation costs per EVSE), then one camera can be focused on that parking/charging area which might cover, for example, 10 parking spaces.

Another advantage of the present invention is that, because the required data processing can be slow relative to high demand input for access control to popular events, the pattern processing can be done at a remote server so that the locally installed cameras can be relatively inexpensive and tied to the network either via wireless modem or Ethernet, or some other type of network. The need to update the images can be as little as every thirty seconds when vehicle activity is noted, and none with no activity. Thus, solar powered, or battery operated cameras can sleep until awakened by movement. Upon sensing movement, the camera can start gathering data and sending to the server. Only minimal electrical drain by the circuitry is required to sense movement.

Motorists who park their vehicles in zones beyond the limits of their profiles (for example, a gas engine vehicle in an EVSE equipped parking spot) can be cited for an infraction or simply billed at the EVSE parking rate whether charging an electric vehicle or not. This allows for a simple flat fee for parking in any specific area and allows the lot owner to install inexpensive EVSE with no access control. There is no reason to have access control because any vehicle parked in that general zone and taking up an EV space will be tracked to that zone and will be billed for being in that zone. If the system is used to monitor EVSE in an EVSE zone or area, then there can be a tie-in with a database of usage and other recording from each EVSE. The system can know where the EV is parked, the exact EVSE space, and this can be tied in time to the power usage at that EVSE. Alternatively, EVSE spaces can also be directly monitored for power usage. However, this raises the cost of installing an EVSE space. Vehicles enter a parking area or parking space will either be “known” (pre-registered) or unknown. Close view and wider view with optional color signature data can be captured from all vehicles. All vehicles can be tracked to determine which parking zones they enter, and in which zone they park. The various zones and their fees can be posted with signage. The unknown vehicle motorist can be required to call or go online and register with the service and enter their license plate number into a database. The system will then be able to backtrack that license plate to the unknown vehicle that entered the parking area, and that vehicle can be added to the database. The motorist can be given the option of registering as transient (short term) or tenant (long term), as they wish, based on the parking area owner's policy. In case of enforcement and billing disputes, all images are available via search capabilities for ID, time and location tracking. The same system can be used to continuously monitor and report on spaces available in the various different zones in the parking facility. The owner may decide to set different values for various areas or attributes of the parking spaces. Furthermore, if EVSE usage needs to be tracked for billing purposes, this can also be tracked by the system based on the vehicle ID, the location, (the EVSE space number) and the time. As stated, individual EVSE metering can be installed and usage sent via wired or wireless communications to a main server in order to correlate vehicle ID, space number and time with power usage.

With any optical system, there can be vehicle parking ambiguities. In the case of open EVSE areas for example, if very similar vehicles enter the parking area at the same access point and at the same time, and if one vehicle goes to an EVSE area and the other does not, the owner may only be able to charge for parking and not for EVSE access since it may be impossible to determine which vehicle used the EVSE. This is the same concept for any parking area with special attributes, such as shade in the summer heat, or proximity to an entrance or exit, etc., and is not limited to EVSE. Of course, if both vehicles go to an area with special attributes, then the owner can bill for both vehicles, and if neither goes to special area, then the owner can only bill for general parking. Therefore, in this special and unlikely situation, when two very similar vehicles enter at the same time and the same location with one going to a special area and one not, thus making it unclear which vehicle went to the special area, then neither vehicle can be billed for special parking access, unless the system also includes an exit camera that can catch the added LPR data upon that vehicle exiting the parking area. The chances of such an event are so small that it does not effect the overall value of the unified parking management system.

In a particular embodiment, a vehicle can be pre-registered online to allow access to a parking area. In another, the vehicle is unknown and must register after entering the parking area via a computer or smart phone or voice, on phone registration.

In addition, this system can offer higher security for employees, teachers and students in all parking areas. Highly visible cameras and signage can add to security. In fact, the wider view cameras of the present invention can also optionally act as general CCTV surveillance cameras if designed for continuous caching and uploading of images to the central server. Initial “wider view” camera installation can be set up near the standard LPR cameras at entrance pinch point(s), and the additional “wider-view” cameras can be set up in strategic “field of view” locations throughout the parking area(s) and zones. These “wider view” cameras can also be limited to covering specific parking spaces or zones within a larger area. Each “wider view” camera can be set up to offer a “fixed view” of a strategic parking area, which becomes tied to a specific number of spaces in a specific parking area. Fixed views can be tied together to cover larger parking areas and a plurality of spaces.

Under the present invention, to achieve the highest degree of convenience, a motorist must, at some point, register the ID (license plate number) of their vehicle. This can be by pre-registration online or by telephone for a particular rate or particular type of space (such as EVSE), or can be done by the motorist after parking. In the latter case, the motorist can either make a cellular telephone call, or enter a website from a mobile phone to register, or a parking facility could have a kiosk or location for registration before the person walks out of, or otherwise leaves, the facility. In particular, such a kiosk could be equipped with BLUETOOTH that could allow registering simply by bringing a particular handheld device like a smartphone in proximity to the kiosk.

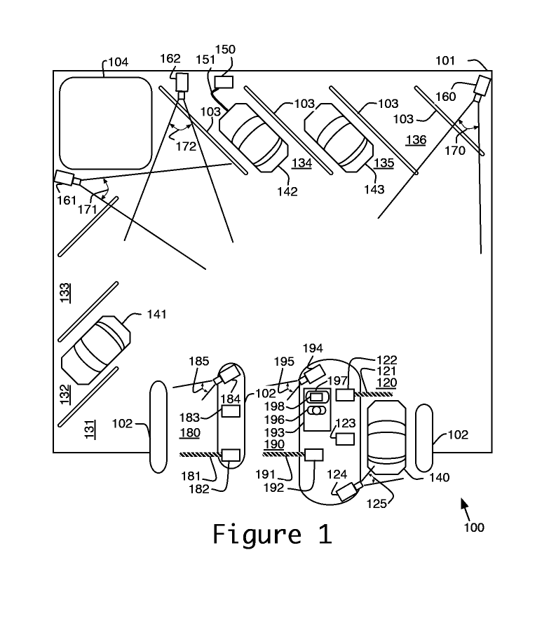

FIG. 1 shows an overview of a parking facility according to the present invention. The following features can be seen in FIG. 1:
100 parking facility.
101 secure perimeter (so cars only enter/leave through designated portals).
102 curbs to help channel vehicular traffic.
103 dividers (e.g., lines, curbs) designated individual parking spaces.
104 pedestrian access to stores, elevator lobby, etc. Parking spots in proximity to this (e.g., 133) are higher value than those with otherwise similar amendments that are further away.
120 entry lane—a portal for entering parking lot 100.
121 entry control gate, opens when transaction is successfully initiated to admit car.
122 entry control gate mechanism.
123 entry kiosk, may give driver prices and instructions.
May spit a ticket for backup, e.g., in case license plate is unreadable.
124 license plate camera (or other device for capturing ‘vehicle characteristic’ upon entry). other characteristics can be used instead or in addition:
   3D scan of vehicle for later recognizing it by shape,
   photographic capture of vehicle, to later recognize by its image and the like.
125 field-of-view (FOV) for camera 124.
131 illegal parking space.
132 ordinary parking space.
133 premium parking space (close to pedestrian access 104).
134 EV parking space.
135 ordinary parking space.
136 ordinary parking space.
140 vehicle entering facility at entry portal 120.
141 vehicle.
142 electric vehicle (EV).
143 vehicle.
150 electric vehicle service equipment (EVSE).
151 electric vehicle charging cable.
160 a transaction monitoring camera.
161 a transaction monitoring camera.
162 a transaction monitoring camera.
170 FOV of camera 160.
171 FOV of camera 161.
172 FOV of camera 162.
180 unattended exit lane, also called ‘exit portal’.
181 exit control gate, opens when transaction is successfully concluded.
182 exit control gate mechanism.
183 self-serve automatic exit kiosk.
displays charges, accepts payment (if an account is not already pre-associated with the vehicle), provides receipt.
184 license plate camera (or other device for capturing ‘vehicle characteristic’ when exiting. for comparison with characteristic captured upon entry, to boost confidence, resolve ambiguities, establish enhanced evidence of transaction)
185 FOV of camera 185.
190 attended exit lane, also called ‘exit portal’.
191 exit control gate (like 181).
192 exit control gate mechanism (like 182).
193 exit booth.
194 license plate camera (or other characteristic capture device, like 184).
195 FOV of camera 194 (like 185).
196 parking lot attendant for assisted transaction.
197 parking management system able to monitor parking transactions by tracking vehicles within parking facility 100.

System 197 has communication with cameras 160-162 for tracking, communication with license plate recognition cameras 124, 184, 194 for determining ‘vehicle characteristics’, and controls gate mechanisms 122, 182, 192 based on the start and completion of parking transactions. System 197 also has communication with automatic portal kiosks 123, 183 for communication with a vehicle operator while beginning and concluding transactions, and with user interface 198, also for concluding transactions. 198 user interface for parking attendant 196, e.g. for accepting cash payments for transactions or assisting a vehicle operator in case of difficulties.

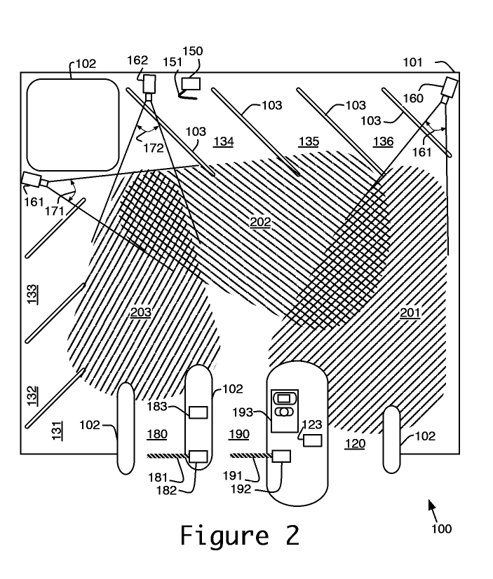

FIG. 2 is an illustration of parking a facility 100 with camera coverage zones overlaid. The following features can be seen in FIG. 2.
201 zone covered by camera 160.
202 zone covered by camera 161.
203 zone covered by camera 162.
Note that zones may overlap each other.
Note that zones are not required to overlap.

Note that some parking spaces may be at least partially within a zone covered by at least one camera (e.g., 131, 132, 134, 135, but that some parking spaces may be entirely outside of all covered zones (e.g., 133, 136).

Note that the zone covered by a camera may be divided into sub-zones, each of which is treated as if they were independent, separate zones, e.g. for a camera directed to have a view of multiple parking spaces, the individual parking spaces might represent individual sub-zones of the camera's overall FOV (none shown).

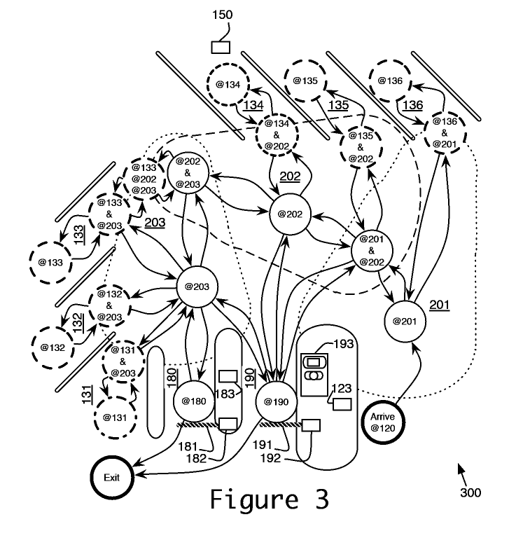

FIG. 3 is a vehicle position state transition diagram 300 which, for the purposes of illustration, is laid out in geographical correspondence to some of the parking facility features in FIGS. 1 & 2. Transition diagram 300 includes a number of states, each labeled herein in correspondence to a position within the parking facility, as determined by entry and exit portals, and zones of coverage by the optical tracking by cameras. Plausible transitions between states are shown as being directed, and some transitions are not reversible (notably, those transitioning from or to arrival and exit portals.
[Arrive @120] the initial state for a vehicle newly arriving at the facility. When a vehicle is here, it could still back away, but after transitioning to the next state, the only departure will be via the exit portals.
[@201] after exiting entry lane 120 and with the entry gate closed behind, the parking transaction is committed. This state is for vehicles visible only to camera 160.
[@136 & 201] is for vehicles transitioning to/from zone 201 in proximity to space 136.
[@201 & @202] is for vehicles transitioning between zones 201 and 202 (in either direction) and so on.

In zones, or zone overlap regions:
[@201], [@202], [@203], [@201 & @202], [@202 & 203]

Transitioning to/from a zone into a parking space:
[@131 & @203], [@132 & @203], [@133 & @201], [@134 & @202], [@135 & @202], [@136 & @201]

States represent conditions corresponding to multiply-covered situations, e.g., [@133 @202 @203], where a vehicle might be detected in zone 202, while also transition to/from zone 203 in proximity to space 133.

For clarity, not all possible states are shown, e.g., there is no state shown covering the transition from zone 203 to exit lane 180.

The transitions from exiting states [@180] and [@190] to [EXIT] conclude the transaction for a vehicle.

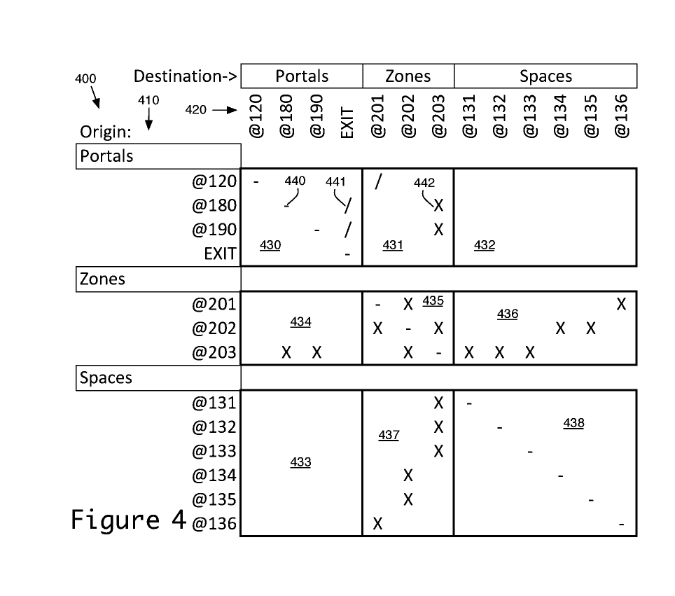

FIG. 4 is a transition table, identifying the legitimate “location” for a vehicle and the allowed transitions. It is not required that a vehicle be in exclusively one location (i.e., it can be in both zone 201 and 202 simultaneously). Non-blank entries in the table indicate legitimate transitions to be accepted based on the observed states from the tracking cameras and state diagram 300.
400 vehicle position transition table, in which non-blank entries mean:
   hyphen: (e.g., 440) identity transitions allowing a vehicle to remain in the same position
   slash: (e.g., 441) one-way (non-reflexive) transition
   ‘X’: (e.g., 422) bi-directional transition (there is a reflexive transition present in the table when the row/column positions are reversed).
410 column labeling vehicle current position.
420 row labeling possible vehicle next position(s).
430 transitions to/from portals: note that there is no “transition to” entry lane @120. A new vehicle just arrives there. Similarly, when leaving the lot by transitioning to EXIT, there is no return.
431, 434, 435, 436, 437 transitions to/from or among zones, all of which are reflexive except the transition in 431 from entry lane 120 to zone 201.

Note: if there were a barrier strip or other one-way limitation within a parking facility, then transitions among zones to either side might be one-way (non-reflexive) also. This can be valuable if a substantial portion of the parking structure is not covered by cameras like 160-162, where a vehicle transitioning into zone without complete coverage is prohibited from returning to more premium parking areas. In this way, comprehensive tracking need only be provided in premium areas, but once having left a premium area (or foregoing entry to it), a vehicle transaction is assured to not include premium parking.
436, 437, transitions to/from individual parking spaces.
438 for this example, transitions between parking spaces are considered unfeasible, e.g., if dividers 103 between parking spaces were curbs. If a situation has a likelihood of vehicular movement between spaces, then this section would have additional transition entries.

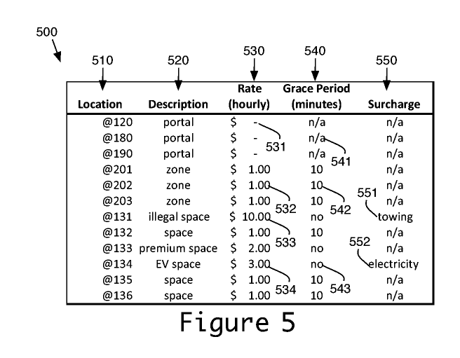

FIG. 5 shows a table of example parking rates
500 table of parking rates by location.
510 column of locations in parking facility 100.
520 description of location.
530 rate charged for occupancy of location (set as a matter of policy).
531 free—no charge for occupying these locations.
532 basic fee, here, $1/hour.
533 premium fee, here, $10/hour for illegal parking in space 131.
534 premium fee, here, $3/hour for parking in space 134 with an EVSE.
540 grace period, in this example by zone, with occupancy of some locations immediately canceling the grace period (again, set as a matter of policy)(see 543).
541 the grace period is not affected by being in these locations.
542 a basic grace period, here for 10-minutes.
543 in some premium locations, as a matter of policy, the grace period may be reduced or canceled.
550 surcharge source—if a vehicle parks in this location, then when determining the final total for the transaction, additional fees may be due based on a surcharge.
551 a towing surcharge for illegal parking.
552 an electricity surcharge for electricity consumed while parking in space 134 (in which case parking management system 197 may also have communication with EVSE 150 or a corresponding electric meter to determine a quantity of or price for electricity consumed while a particular vehicle was in state [@134].

Note that some premium spaces (e.g., 133) do not have corresponding surcharges, just a higher rate (e.g., $2 rather than $1).

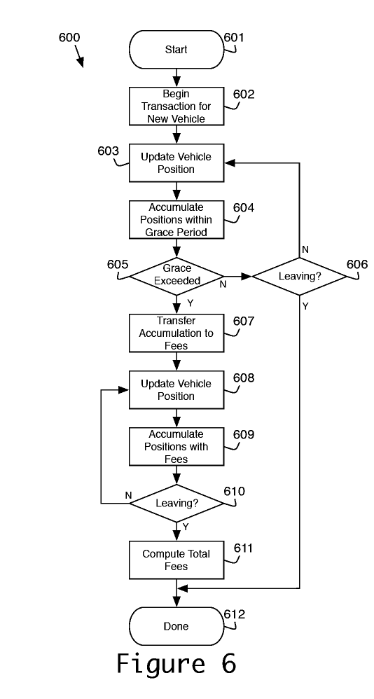

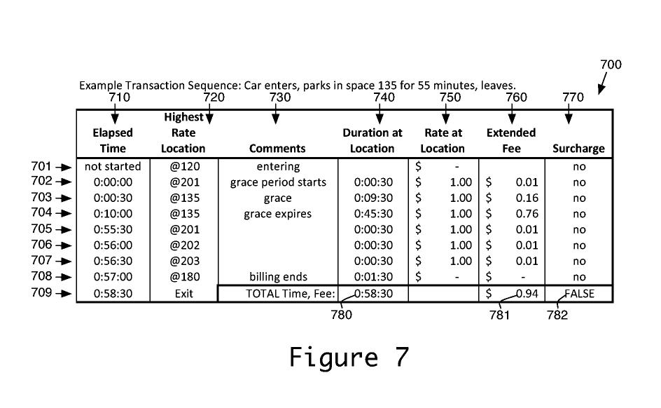

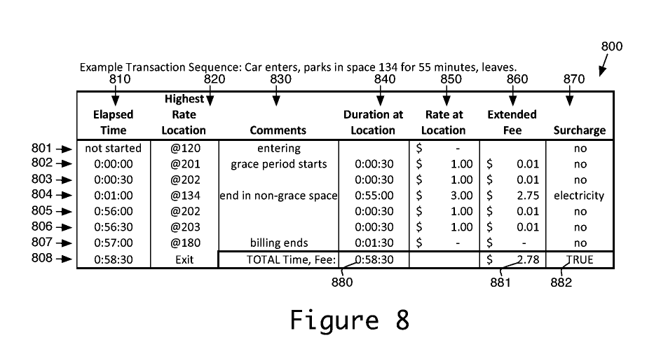

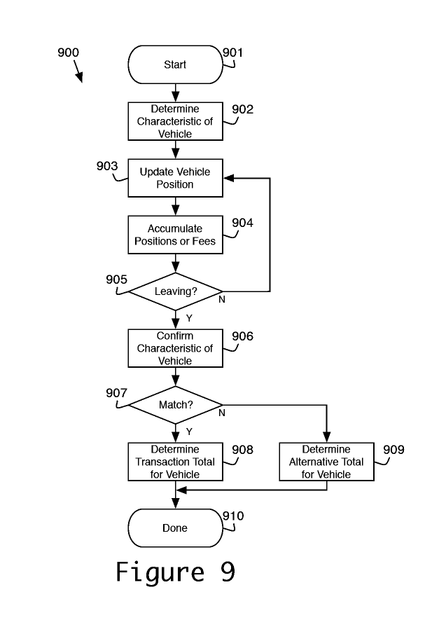

FIG. 6 is a flowchart for a process 600 for managing the transaction for a vehicle in a parking facility. Process 600 pays particular attention to the grace period. A different embodiment of the process depicted in FIG. 9 emphasizes determination of vehicle characteristics at entry and exit (e.g., license plate recognition) to improve confidence in the events associated with the vehicle (e.g., as in FIGS. 7 and 8).

The flow chart of FIG. 6 starts at 601 and begins a transaction for a new vehicle at 602. The vehicle's position is updated iteratively at 603 by accumulating positions in 604 and looping back from 606 if the vehicle is not leaving. If the vehicle leaves, flow 606 exits the routine at 612. The grace period is tested in this position loop at 605. As long as the grace period is not exceeded, and the vehicle is not leaving, the position is iteratively updated at 603. If the grace period is exceed at 605, the accumulation is transferred to fees at 607 and again, the vehicle's position is updated at 608. The positions with fees are accumulated in 609 as long as the vehicle is not leaving 610. 610 loops back to 608 to again iteratively update the vehicle position in 608. If the vehicle is leaving in 610, the total fees are computed in 611 before terminating in 612.

FIG. 7 shows a table 700 of data representing sequence of events 701-709 observable (or in the case of grace period expiration event 704, determinable) by the system 197 in which each row corresponds to an event, as might be generated and used or recorded by system 197. In this example, a vehicle enters the facility, parks in space 135 for about 55 minutes, then leaves. As a matter of policy recorded in table 500, vehicles are charged for the time spent moving to and from their parking space, though the present invention can implement a different policy. In the example given, the total duration at 780 was 58 minutes, the extended fee 781 was $0.94, and there was no surcharge 782.

The event table 700 has columns for elapsed time 710, highest rate location 720, comments 730, duration at location 740, rate at that location 750, any extended fee 760 and a yes/no for a surcharge 770. The total time row including duration 780, extended fee 781, and whether there was a surcharge 782 can be used for billing and other records.
Col. 710 is the elapsed time from the start of the transaction to the time of the event.
Col. 720 is the location occupied by the vehicle and having the highest rate (e.g., when a vehicle is occupying multiple locations simultaneously, bill according to the highest appropriate rate. (A different policy might call for the lowest rate).
Col. 730 are comments to aid understanding of the event.
Col. 740 is the duration spent by the vehicle in the location corresponding to the event.
Col. 750 is the rate for the location in column 720 (as shown in rate table 500).
Col. 760 is the extended fee for occupying the location for that duration.
Col. 770 is a note regarding a surcharge for occupying the location.
780 is the total duration within the facility (the sum of the individual event durations).
781 is the total fee (excluding surcharges) for occupying the locations.
782 is a determination of whether any surcharge is due, which since false, means none.

FIG. 8 shows a table 800 of data representing a different sequence of events 801-808 observable by the system 197, this time for a car that enters and parks for the same duration, but in EVSE-enabled parking space 133. Here, the grace period is canceled (per policy represented in col. 540 of rate table 500) as soon as the vehicle occupies space 134, and so does not need to be represented as a separate event (as was 704).
Cols. 810, 820 . . . 870 are as corresponding columns 710, et seq.
880 is the total duration within the facility (identical to that of 780).
810 is the total fee (excluding surcharges) for occupying the locations, which is higher for this transaction because space 134 is a premium space and 135 is not)
820 is a flag to the system that a surcharge is further due, which is to be based on the electricity drawn from the EVSE 150 during the 55 minutes that the vehicle occupied space 134. System 197 may communicate with EVSE 150 to determine that value.

FIG. 9 shows another flowchart depicting process 900 of managing the transaction for a vehicle in a parking facility, this one making use of the license plate cameras (e.g., 124, 184, 194) or other vehicle characteristic-determining devices. In this embodiment of a characteristic of the vehicle is determined at 902 as the vehicle enters, and again at 906 as the vehicle is prepared to leave. A successful comparison at 907 confirms (or at least increases the confidence) that the vehicle is the one tracked repeatedly at step 903. If successful, the total fees are charged at 908. Otherwise, an alternative total is determined (which may represent a reprocessing of the records in one or more tables 700, 800, representing event data that is associated with the current vehicle, but at a lower confidence).

In summary, under the present invention, the owner can know where a vehicle went in the parking area in two different manners: “dense” tracking and “sparse” tracking. Dense tracking requires a plurality of overlapping camera/sensor views of every space in the parking area, while sparse tracking only requires cameras monitoring an area of interest or higher value, such as a parking zone with special features; perhaps closer to a footpath or entrance, or parking spaces with EVSE. These two different approaches can lead to different costs of installation and maintenance.

Several descriptions and illustrations have been presented to aid in understanding the present invention. One with skill in the art will realize that numerous changes and variations may be made without departing from the spirit of the invention. Each of these changes and variations is within the scope of the present invention.

1. A method to conduct a parking transaction comprising:
a) tracking (608, 903), with a parking management system (198) having communication with a plurality of cameras (160-162) in a parking facility (100), a current position of a first vehicle in the parking facility, movement of the first vehicle within the facility visible to at least one of the plurality of cameras;
b) accumulating (609, 904), with the parking management system, a fee, corresponding to the first vehicle, at a rate (530) corresponding to the current position (510) of the vehicle;
c) repeatedly performing steps a) and b) until the vehicle leaves the parking facility; and,
d) charging the amount of the fee (781, 881) as the vehicle leaves the parking facility.

2. The method of claim 1 further comprising:
e) determining (902) a characteristic of the vehicle, with the parking management system, the parking management system having communication with at least one sensor able to detect the characteristic, as the vehicle attempts to enter the facility;
f) confirming (906) the characteristic, with the parking management system, of the vehicle as the vehicle leaves the facility;
whereby confidence in the transaction is increased.

3. The method of claim 2 wherein the characteristic is a license plate number and the sensor is a camera.

4. The method of claim 3 wherein the first vehicle is pre-registered with the parking management system and a second vehicle is not, the method further comprising:
f) admitting the first vehicle based on the license plate number being known to the parking management system; and,
g) denying admittance to the second vehicle.

5. The method of claim 2 wherein the characteristic is a color and the sensor is a camera.

6. The method of claim 2 wherein the characteristic is a shape of the vehicle and the sensor comprises a camera.

7. The method of claim 1 wherein the parking facility has at least a first and second parking spaces, a first rate corresponding to the first parking space being different than a second rate corresponding to the second parking space.

8. The method of claim 7 wherein at least one parking space is associated with a surcharge.

9. The method of claim 1 wherein a first parking space corresponds to an electric vehicle service equipment (EVSE).

10. The method of claim 9 wherein the parking management system has communication with the EVSE to determine an amount of power used while the current position of first vehicle is the first parking space.

11. The method of claim 1 wherein the parking facility offers a grace period for a particular portion of the parking facility, the method comprising:
e) tracking (603), with the parking management system, the current position of a first vehicle in the parking facility until one of the grace period expires and the vehicle leaves the particular portion of the parking facility;
step e) performed before steps a), b), c) and d).

12. A method of managing a parking facility comprising:
determining a vehicle ID using an LPR system upon vehicle entry;
tracking said vehicle in the facility using a plurality of wide-view cameras, wherein optical data from said wide-view cameras is processed using pattern recognition and motion detection to produce vehicle location data;
determining a location where said vehicle parks in the facility;
requiring a driver of said vehicle to register said vehicle ID either online, by telephone or at a registration station;
billing said vehicle for parking based on said location and time parked at said location.

13. The method of claim 12 further comprising citing any vehicle that parks without registering said vehicle ID.
